(19) United States
(12) Patent Application Publication
(10) Pub. No.: US 2022/0266795 A1
(43) Pub. Date: Aug. 25, 2022

(54) VEHICLE CONTROL SYSTEM

(71) Applicant: TOYOTA JIDOSHA KABUSHIKI KAISHA, Aichi-ken (JP)

(72) Inventors: Hiroyasu HADANO, Toyota-shi (JP); Kunihiro MURAKAMI, Okazaki-shi (JP); Kentaro OYA, Toyota-shi (JP); Takaaki INOKUCHI, Nagoya-shi (JP)

(21) Appl. No.: 17/668,308

(22) Filed: Feb. 9, 2022

(30) Foreign Application Priority Data
Feb. 12, 2021 (JP) 2021-020610

(51) Int. Cl. B60R 25/20; B60R 25/34

(52) U.S. Cl. CPC B60R 25/209; B60R 25/34

(57) ABSTRACT

An engine is prevented from being started by a remote operation in a case where an angle of inclination detected by an acceleration sensor is not within a predetermined angle range in a situation where a shift position is not set to a neutral position in a manual transmission.

### CROSS REFERENCE TO RELATED APPLICATION

This application claims priority to Japanese Patent Application No. 2021-020610 filed on Feb. 12, 2021, which is incorporated herein by reference in its entirety including the specification, claims, drawings, and abstract.

### TECHNICAL FIELD

The present disclosure relates to a vehicle control system for starting an engine by a remote operation from outside a vehicle before a user gets in the vehicle.

### BACKGROUND

There has been well known a function of starting an engine through a remote operation before a user gets in a vehicle. In a vehicle having a remote air conditioning function, for example, because a compressor in an air conditioner is driven by the engine, it is necessary for the engine to be started before actuating the air conditioner through the remote operation. For example, JP 2010-174747 A discloses a vehicle having a function of starting an engine by a remote operation before a user gets in the vehicle.

In a case where a vehicle equipped with the above-described remote air conditioning function has a gear shifting mechanism composed of a manual transmission, when a shift position is not in a neutral position in the vehicle which is parked, starting the engine should be prevented in consideration of a situation where stopping stability of the vehicle is not sufficiently secured.

With this in view, the present disclosure is directed to provide a vehicle control system capable of checking stopping stability of a vehicle before an engine is started in response to a remote operation.

### SUMMARY

In an aspect of the present disclosure, a vehicle control system is configured to start an engine in response to a remote operation from outside a vehicle before a user gets in the vehicle, the vehicle having a gear shifting mechanism composed of a manual transmission. The vehicle control system according to this aspect of the present disclosure includes an inclination angle detector configured to detect an angle of inclination of the vehicle, a shift position detector configured to detect a shift position in the manual transmission, and a controller configured to prevent the engine from being started by the remote operation when the shift position is not set to a neutral position in the manual transmission in a state where the angle of inclination detected by the inclination angle detector is outside of a predetermined angle range.

According to another aspect of the present disclosure, in the vehicle control system, the controller may be further configured to prevent the engine from being started by the remote operation when a parking brake is not activated.

According to another aspect of the present disclosure, in the vehicle control system, the controller may be further configured to issue, when the engine is not started by the remote operation, a warning to a user who is operating the vehicle.

According to the vehicle control system of this disclosure, stopping stability of the vehicle can be checked when the engine is started by the remote operation.

### BRIEF DESCRIPTION OF DRAWINGS

Embodiments of the present disclosure will be described based on the following figures, wherein:

FIG. 1 is a schematic diagram showing a vehicle according to an embodiment;

FIG. 2 is a block diagram showing a configuration of a controller according to an example of the embodiment; and

FIG. 3 is a flowchart showing a flow of remotely controlling an air conditioner.

### DESCRIPTION OF EMBODIMENTS

Hereinafter, an example of an embodiment according to this disclosure will be described in detail. In the following description, specific shapes, materials, directions, numerical values, and other features are presented by way of illustration for facilitating understanding of the present disclosure, and may be changed as appropriate depending on applications, purposes, specifications, and the like.

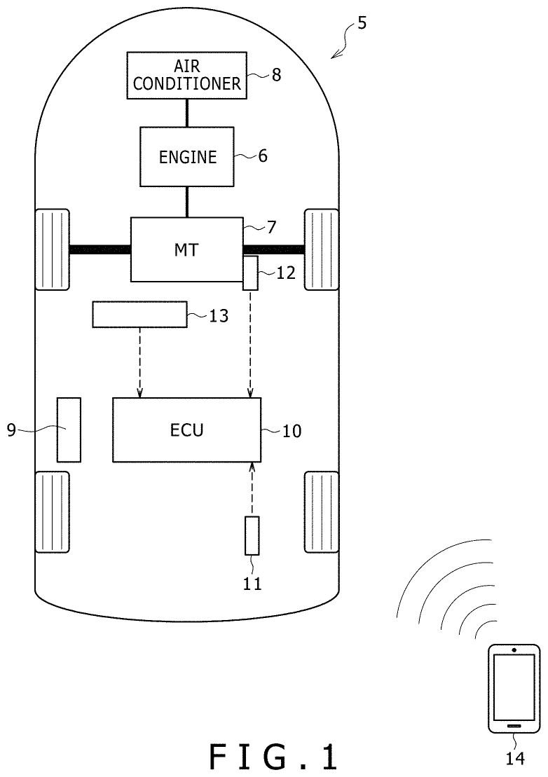

A vehicle 5 equipped with a vehicle control system according to an example of an embodiment is described with reference to FIG. 1. FIG. 1 is a schematic diagram showing the vehicle 5.

As shown in FIG. 1, the vehicle control system is installed in the vehicle 5. The vehicle 5 in this example is a vehicle which is driven by means of power from an engine 6. It should be noted that the vehicle 5 may be, for example, a hybrid electric vehicle. In the vehicle 5 of this example, the power from the engine 6 is transferred through a manual transmission 7 employed as a gear shifting mechanism. In the vehicle 5, the power from the engine 6 may be transferred through an automatic transmission, for example.

The vehicle 5 is equipped with an air conditioner 8 for cooling or heating a vehicle compartment. The air conditioner 8 has a freeze cycle device equipped with a compressor. The compressor of the air conditioner 8 is driven by the engine 6. The air conditioner 8 is configured to be actuatable via a remote air conditioning function, which will be described below, in response to a remote operation of a user before the user gets in the vehicle 5. In addition, actuation of the air conditioner 8 via the remote air conditioning function involves starting of the engine 6.

In this example, while a configuration to actuate the air conditioner 8 through the remote operation from outside the vehicle 5 before the user gets in the vehicle is described as an example of starting the engine in response to the remote operation from outside the vehicle 5 before the user gets in the vehicle 5, the present disclosure is not limited to the configuration, and may be applied to a configuration to start only the engine 6 or a configuration to actuate other devices involving starting of the engine 6.

The vehicle 5 is equipped with an electric parking brake 9 as a parking brake. The electric parking brake 9 is a device for allowing the user to activate and release the parking brake by operating a button. The button for operating the electric parking brake 9 in this example is installed in an operation unit 13 which will be described below.

The vehicle control system includes a controller 10 (such as an Electronic Control Unit, ECU). The vehicle control system is a control system for implementing remote air conditioner control to actuate the air conditioner 8 in response to the remote operation before the user gets in the vehicle 5, which will be described in detail below. The vehicle control system can ensure that stopping stability of the vehicle 5 is identified when a remote air conditioning function is activated, which will be described in detail below.

The vehicle control system includes an acceleration sensor 11 for detecting an acceleration of the vehicle 5, a shift position sensor 12 functioning as a shift position detector for detecting a shift position in the manual transmission 7, the operation unit 13 in which the button for operating the electric parking brake 9 is installed, and a smartphone 14 used for remotely actuating the air conditioner 8 by the user.

Here, when a longitudinal direction of the vehicle 5 extends along a horizontal direction, the acceleration of gravity acting on the vehicle 5 (along the vertical downward direction) has a component equal to zero in the longitudinal direction of the vehicle 5. On the other hand, when the longitudinal direction of the vehicle 5 is inclined, the acceleration of gravity acting on the vehicle 5 in the longitudinal direction thereof has a component which becomes greater in proportion to an inclination of the longitudinal direction of the vehicle 5. The acceleration sensor 11 is a sensor for detecting the acceleration of the vehicle 5 in the longitudinal direction thereof. For this reason, when the longitudinal direction of the vehicle 5 is inclined, the component of the acceleration of gravity acting on the vehicle 5 in the longitudinal direction thereof can be detected by means of the acceleration sensor 11, and the inclination of the longitudinal direction of the vehicle 5 can be found based on the detected component. Therefore, the acceleration sensor 11 is employed as an inclination angle detector in this example.

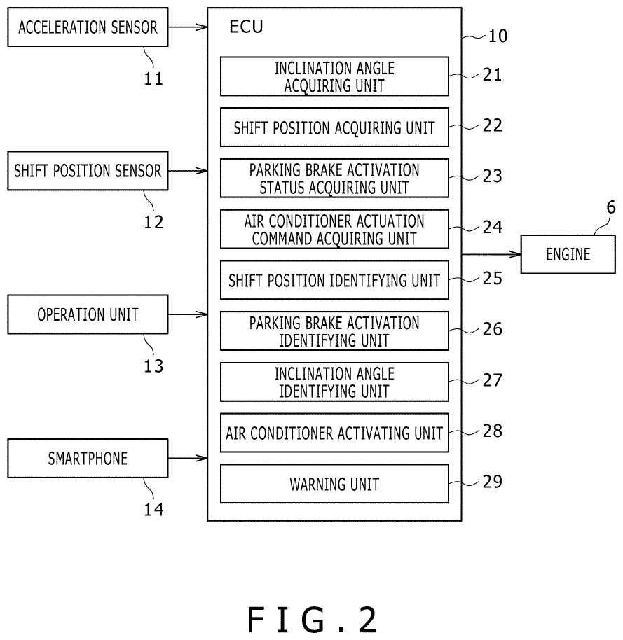

Next, the controller 10 is described with reference to FIG. 2. FIG. 2 is a schematic diagram showing a configuration of the controller 10.

The controller 10 includes a computation processor composed of a CPU (Central Processing Unit) and a storage such as a RAM (Random Access Memory) and a ROM (Read Only Memory), and is configured to perform signal processing in accordance with a program previously stored in the ROM while using a temporal storage function of the RAM.

As shown in FIG. 2, the controller 10 is connected to the acceleration sensor 11, the shift position sensor 12, the operation unit 13, and other units to receive signals from the sensors and units. Further, the controller 10 is wirelessly connected to the smartphone 14 to receive a signal transmitted from the smartphone 14. Still further, the controller 10 is also connected to the engine 6 to transmit a signal to the engine 6.

The controller 10 includes an inclination angle acquiring unit 21 which acquires an angle of inclination of the longitudinal direction of the vehicle 5 detected by the acceleration sensor 11, a shift position acquiring unit 22 which acquires the detected shift position in the manual transmission 7 from the shift position sensor 12, a parking brake activation status acquiring unit 23 which acquires an activation status of the electric parking brake 9, and an air conditioner actuation command acquiring unit 24 which acquires an air conditioner actuation command that is wirelessly transmitted from the smartphone 14 by the user when the vehicle is parked.

In addition, the controller 10 further includes a shift position identifying unit 25 which identifies whether or not the shift position is set to the neutral position in the manual transmission 7, a parking brake activation identifying unit 26 which identifies whether or not the electric parking brake 9 is activated, an inclination angle identifying unit 27 which identifies whether or not the angle of inclination of the vehicle 5 is within a predetermined angle range, an air conditioner actuating unit 28 which actuates the air conditioner 8, and a warning unit 29 which issues a warning to inform the user of insecure stopping stability of the vehicle 5.

The shift position identifying unit 25 has a function of identifying whether or not the shift position acquired from the above-described shift position acquiring unit 22 is in the neutral position. When the shift position identifying unit 25 identifies that the shift position is not in the neutral position, because the stopping stability of the vehicle 5 is not fully secured, the controller 10 prevents the engine 6 from being started by the remote operation.

The parking brake activation identifying unit 26 has a function of identifying whether or not the electric parking brake 9 is activated, based on the activation status of the electric parking brake 9 acquired from the parking brake activation status acquiring unit 23. When the parking brake activation identifying unit 26 identifies that the electric parking brake 9 is not activated, the controller 10 prevents the engine 6 from being started by the remote operation in light of the stopping stability of the vehicle 5 that is not fully secured.

In a case where a lever type hand brake is installed as the parking brake, for example, the parking brake activation identifying unit 26 may identify that the lever type hand brake is activated when an angle of the lever type hand brake is greater than or equal to a predetermined angle.

The inclination angle identifying unit 27 has a function of identifying whether or not the angle of inclination acquired from the above-described inclination angle acquiring unit 21 is within a predetermine angle range. When the angle of inclination is not identified as being within the predetermined angle range, because the stopping stability of the vehicle 5 is not fully secured, the controller 10 prevents the engine 6 from being started by the remote operation.

The air conditioner actuating unit 28 has a function of actuating the air conditioner 8 when the air conditioner actuation command is acquired by the air conditioner actuation command acquiring unit 24. Meanwhile, the air conditioner actuating unit 28 also has a function of preventing actuation of the air conditioner 8, regardless of the presence of the air conditioner actuation command acquired by the air conditioner actuation command acquiring unit 24, when the shift position identifying unit 25, the parking brake activation identifying unit 26, or the inclination angle identifying unit 27 determines in light of the situation that the stopping stability of the vehicle 5 is not fully secured, to thereby prevent the engine 6 from being started by the remote operation.

The warning unit 29 has a function of causing the smartphone 14 to output a warning sound or a warning speech when the shift position identifying unit 25, the parking brake activation identifying unit 26, or the inclination angle identifying unit 27 determines to prevent the engine 6 from being started by the remote operation, in light of the situation that the stopping stability of the vehicle 5 is not fully secured.

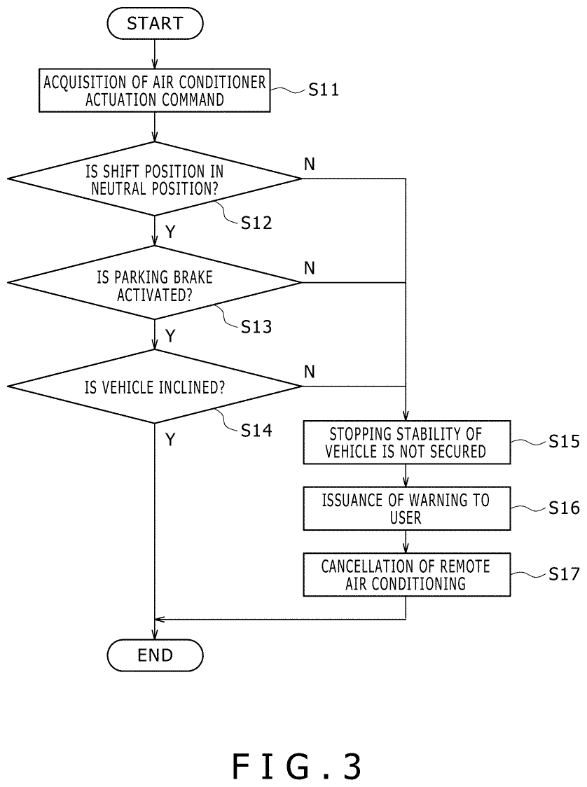

A flow of the remote air conditioner control performed by the controller 10 is described with reference to FIG. 3.

In step S11, the user transmits an air conditioner actuation command signal by means of the smartphone 14 before getting in the vehicle, and the air conditioner actuation command acquiring unit 24 acquires the transmitted air conditioner actuation command signal.

In step S12, the shift position identifying unit 25 identifies whether or not the shift position is set to the neutral position in the manual transmission 7. When the shift position is identified as any position other than the neutral position, operation moves to step S15. In step S13, the parking brake activation identifying unit 26 identifies whether or not the electric parking brake 9 is activated. When the electric parking brake 9 is not identified as being activated, operation moves to step S15.

In step S14, the inclination angle identifying unit 27 identifies whether or not the angle of inclination acquired by the inclination angle acquiring unit 21 is within the predetermined angle range. When the angle of inclination is not identified as being within the predetermined angle range, operation moves to step S15.

In step S15, the engine 6 is prevented, due to insecure stopping stability of the vehicle 5, from being started by the remote command. In step S16, the warning unit 29 issues the warning sound or speech to the user via the smartphone 14 to inform the user of the insecure stopping stability of the vehicle 5. In step S17, the air conditioner actuation command signal is released by the user, or when such a release operation is not performed by the user for a predetermined length of time, the remote operation for actuating the air conditioner 8 is cancelled.

It should be noted that the above-described embodiment and modifications thereof are not presented to limit the present disclosure, and may be changed or improved in various ways without departing from the scope of matters defined in the accompanying claims.

1. A vehicle control system for starting an engine in response to a remote operation from outside a vehicle before a user gets in the vehicle, wherein the vehicle comprises a gear shifting mechanism which is a manual transmission, the vehicle control system comprising:
an inclination angle detector configured to detect an angle of inclination of the vehicle;
a shift position detector configured to detect a shift position in the manual transmission; and
a controller configured to prevent the engine from being started by the remote operation when the angle of inclination detected by the inclination angle detector is not in a predetermined angle in a situation where the shift position is not set to a neutral position in the manual transmission.

2. The vehicle control system according to claim 1, wherein the controller is further configured to prevent the engine from being started by the remote operation when a parking brake is not activated.

3. The vehicle control system according to claim 1, wherein the controller is further configured to issue a warning toward the user operating the vehicle, when the engine is not started by the remote operation.

4. The vehicle control system according to claim 2, wherein the controller is further configured to issue a warning toward the user operating the vehicle, when the engine is not started by the remote operation.
